(19) United States
(12) Patent Application Publication
(10) Pub. No.: US 2005/0285590 A1
(43) Pub. Date: Dec. 29, 2005

(54) AC magnetic tracking system with non-coherency between sources and sensors

(76) Inventors: Robert F. Higgins, Richmond, VT (US); Herbert R. Jones JR., Williston, VT (US); Allan G. Rodgers, Jericho, VT (US)

Correspondence Address: John G. Posa;Gifford, Krass, Groh, Sprinkle,, Anderson & Citkowski, P.C., PO Box 7021, Troy, MI, 48007-7021, US

(21) Appl. No.: 11/147,888

(22) Filed: Jun. 8, 2005

Related U.S. Application Data
(60) Provisional application No. 60/577,860, filed on Jun. 8, 2004.

(51) Int. Cl. G01J 1/20

(52) U.S. Cl. 324/207.17; 324/207.11

(57) ABSTRACT

In an AC magnetic tracker one or more multi-axis field sources, each operating at a different frequency, or frequency set, are detected and tracked in three-dimensional space, even when wireless or otherwise not physically connected to the tracking system. Multiple sources can be tracked simultaneously as they each operate with their own unique detectable set of parameters. The invention not only provides the ability to uniquely identify one or more sources by their frequencies, but also to synchronize with these frequencies in order to measure signals that then allow tracking the position and orientation (P&O) of the source(s). Further, these sources need not be present at the time of system start-up but can come and go while being detected, discriminated and tracked. It also should be noted that application of such systems in multiples with more sensors not synchronized to a source or sources also could be employed to give the reverse appearance of a known source phase and incoherency with the sensors.

### REFERENCE TO RELATED APPLICATION

This application claims priority to U.S. Provisional Patent Application Ser. No. 60/577,860, filed Jun. 8, 2004, the entire content of which is incorporated herein by reference.

### FIELD OF THE INVENTION

This invention relates generally to AC magnetic tracking systems and, in particular, to detecting and establishing phase coherency between magnetic signal sources and sensors.

### BACKGROUND OF THE INVENTION

Position and orientation tracking systems (“trackers”) are well known in the art. For example, U.S. Pat. Nos. 4,287,809 and 4,394,831 to Egli et al.; U.S. Pat. No. 4,737,794 to Jones; U.S. Pat. No. 4,314,251 to Raab; and U.S. Pat. No. 5,453,686 to Anderson, are directed to AC electromagnetic trackers. U.S. Pat. No. 5,645,077 to Foxlin discloses an inertial system, and combination systems consisting of two different trackers, such as optical and magnetic, are described in U.S. Pat. No. 5,831,260 to Hansen and U.S. Pat. No. 6,288,785 B1 to Frantz et al. Other pertinent references include U.S. Pat. No. 5,752,513 to Acker et al. and U.S. Pat. No. 5,640,170 to Anderson.

In the classical AC magnetic tracking system there typically is a single, static source of the three-axis fields which can be detected by multiple sensors which are free to move about a nearby volume (FIG. 1). Past magnetic systems wishing to cover more distance have created a larger source and driven it at high energy levels and then often even enlarged on that. This approach (see FIG. 2) always has proved difficult since the magnetic near field drops off as the third order of range from the source. That is, the signal is proportional to 1/r³.

Another factor is the error signal caused by magnetic signals creating responses that distort data because of eddy currents induced in nearby conductive materials. Although there is controversy over whether distortion is less or greater for pulsed DC or for AC magnetic trackers, in general there is very little difference if the objective is to obtain updates of tracking data very rapidly where stretching of the pulsed DC cycle to allow transients to decay prior to data collection is not allowed.

Although the desired direct magnetic signal and the eddy current distortion signal in theory maintain a constant ratio with energy level, there is a nonlinear phenomenon which alters this constant ratio. When operating at or above the signal level where the nonlinearity occurs, proportionality holds. Consequently, increasing source drive in order to increase operating range creates no benefit over most of the volume because distortion continues as a serious problem. Hence, a large magnetic field source is quite limited in extending operating range. Reversal of the source and sensor roles here offers an alternative for covering a larger volume.

If the source drive level is kept low such that the effects of secondary fields from eddy currents tends to fall at or below the noise floor of the sensing circuitry, that is the source-sensor coupling range is kept short, distortion is rarely a significant problem. In short, the nonlinearity of the noise floor acts as a natural “filter” against the weaker eddy current fields, which must cover much more distance to where the eddy currents are generated and onward to the sensor than does the direct signal. Therefore, if we were to distribute multiple sensors along the periphery of a volume that exceeds the normal source-sensor operating range, then a small, low power source acting as a “sensor” offers the opportunity to track an object over a large volume (see FIG. 3) without eddy current distortion being a derogatory factor.

Of course, operation of several static sensors in order to track a source pseudo-“sensor” raises the issue of maintaining several movement reference points in the volume. That is, there can be one at each sensor. The track of position and orientation (P&O) reported out to the host computer must be referenced to a common point. This point could be one of the sensors or some arbitrary point known by the system. Fortunately, referencing movement back to a common point is a relatively simply geometry problem with somewhat more complex bookkeeping of the various known sensor data points and the computation of track data. The benefits that make this worthwhile are avoidance of raising eddy current distortion and still maintaining strong signals throughout a large volume.

What makes this tracking over a larger area difficult is the incoherency of signal frequencies between a remote wireless source and the tracking sensor(s). Tracking of both regimes of sensors from a source and sources from one or more sensors (FIG. 4) has been done for many years as long as they are connected to a single set of electronics. However, existing systems do not provide the freedom to move through a 3D volume with or without being wired.

Initial landmark AC tracker literature made no distinction between whether the source or the sensors were static or moving. It simply states that the position and orientation (P&O) reported was the P&O relative to each other. In some later disclosures the concept of making the source(s) move and leaving the sensor(s) static was given innovative stature nevertheless. However, the systems cited remained tethered through cabling and greatly simplified the engineering problem of signal detection, synchronization and tracking.

The advent of microcircuits improved battery longevity and more sensitive receiving circuitry as well as providing significantly more cost effective processing. This has made possible wireless field sources which can generate detectable signals of sufficient strength for tracking and do so for at least an hour before battery re-charging. The consequence of this situation is that small 3-axis field sources now offer a way to achieve wireless P&O tracking without the need of radio links if on-the-fly signal detection and synchronization can be provided for small wireless field sources.

Several previous patents deal with tracking the movement of passive sensors relative to a stationary source of AC magnetic fields. U.S. Pat. No. 4,054,881 to Raab is one example. Tracking of remote sources with sensors is one subject of U.S. Pat. No. 6,188,355 to Gilboa. Gilboa also discusses the source being wireless under several constraints for achieving synchronization between the source signals and the sensors. In one embodiment there is a requirement to switch the wireless source and the tracking sensors back and forth between transmit and receive in order to obtain synchronization between them. In another embodiment there is a requirement that the three frequencies generated, one for each leg of the transmitting coil, be harmonically related. In yet another embodiment reception of a threshold triggering event at the wireless source in order to start all transmitted signals in unison is explained. These constraints, plus a requirement to perform calibrations at over 32 position and 32 orientation settings, leads to significant complexity, considering that phase adjustments are subject to drift over time.

### SUMMARY OF THE INVENTION

In an AC magnetic tracker this invention broadly enables one or more multi-axis field sources, each operating at a different frequency, or frequency set, to be detected and tracked in three-dimensional space, even when wireless or otherwise not physically connected to the tracking system. Multiple sources can be tracked simultaneously as they each operate with their own unique detectable set of parameters. This invention not only provides the ability to uniquely identify one or more sources by their frequencies, but also to synchronize with these frequencies in order to measure signals that then allow tracking the position and orientation (P&O) of the source(s). Further, these sources need not be present at the time of system start-up but can come and go while being detected, discriminated and tracked.

A source may be tracked if it is wireless and battery-operated or powered by another system due to the ability to synchronize and achieve coherency. Also, due to the reciprocity between ‘sources’ and ‘sensors’ as discussed above, inverse operation is also possible; that is, where it is desirable to synchronize one or more sensors with a source having a known phase.

### BRIEF DESCRIPTION OF THE DRAWINGS

FIG. 1 is a block diagram of a typical AC magnetic tracking system;

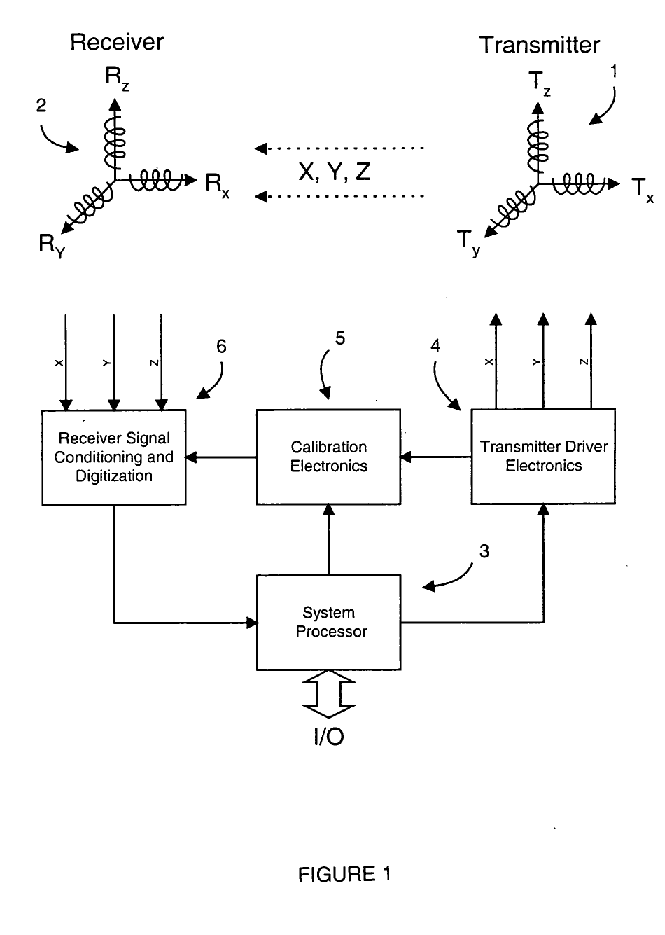

FIG. 2 is a block diagram showing how past magnetic systems wishing to cover more distance have created a larger source and driven it at high energy levels;

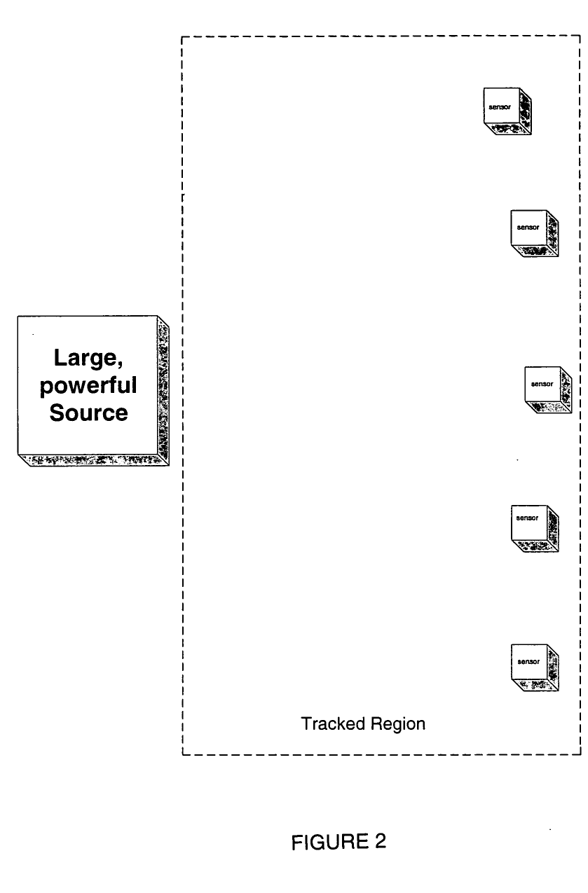

FIG. 3 shows how, if one were to distribute multiple sensors along the periphery of a volume that exceeds the normal source-sensor operating range, then a small, low power source acting as a “sensor” offers the opportunity to track an object over a large volume;

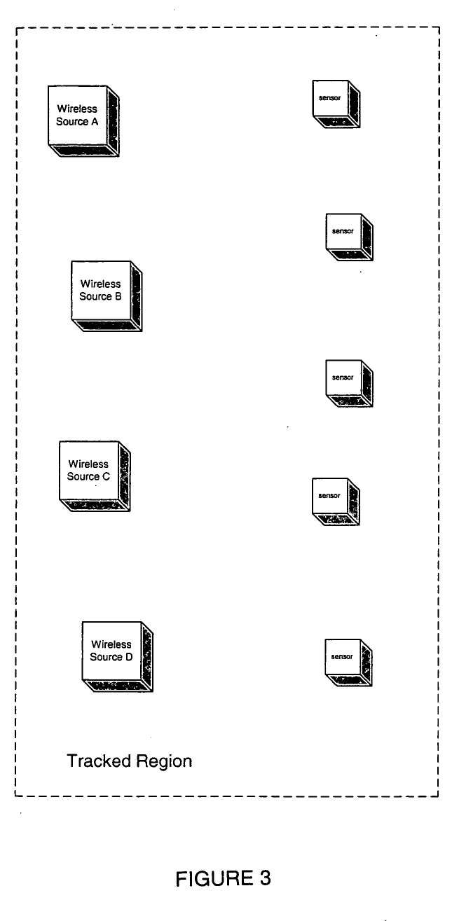

FIG. 4 is directed to the reciprocity of the tracking relationship; and

FIG. 5 depicts a wireless source(s) whose signals are detected by a true sensor connected to an electronics unit.

### DETAILED DESCRIPTION OF THE INVENTION

If one desires a remote “sensor” to track, it really does not matter whether the source or sensor is tracked because the P&O calculation is the relative position and orientation between source and sensor. If adequate sensitivity and low noise performance can be achieved with the sensor and a means can be found to determine the source frequency/frequency set and become synchronized with this external source of orthogonal fields, then the source can be remotely disposed as a “pseudo-sensor.” Furthermore, once this is accomplished and there is no constraint placed on the source signals except that they create signals from a frequency population consistent with the system, there can be sources both wireless and wired being tracked as pseudo-sensors. Applicable wireless configurations are disclosed in co-pending U.S. Provisional Patent Application Ser. No. 60/578,128, the entire content of which is incorporated herein by reference.

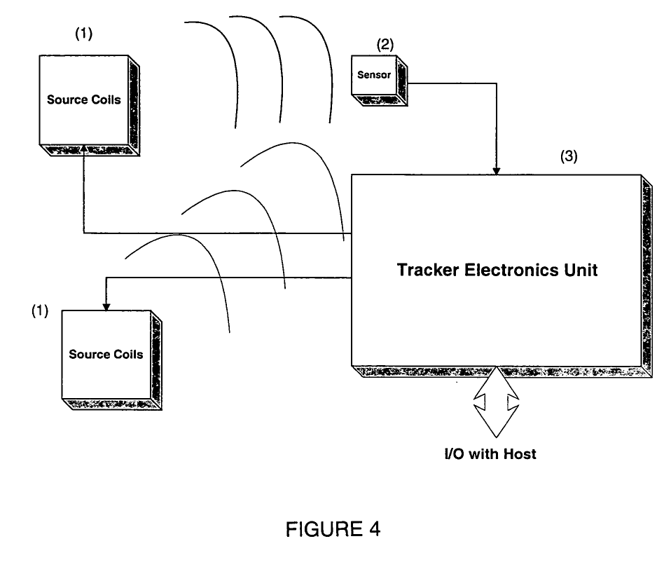

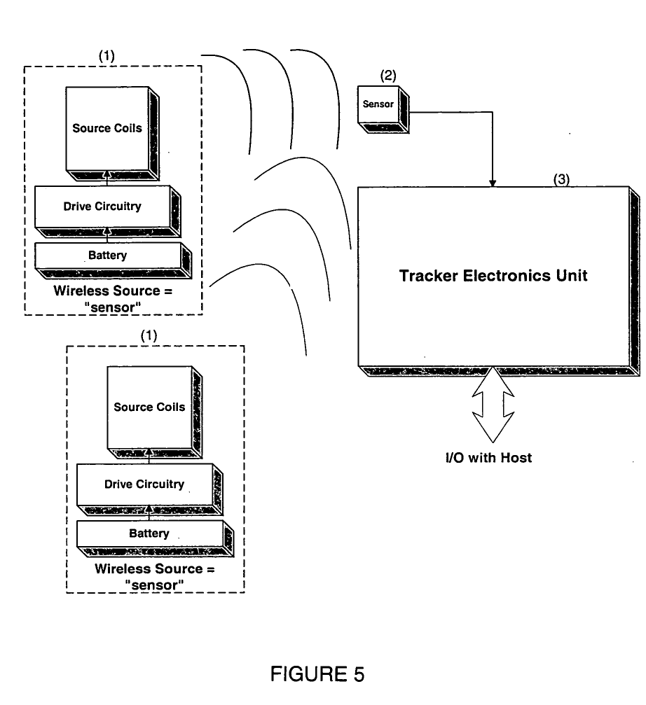

The reciprocity of the tracking relationship is shown in FIG. 4, where two “sensors” (1) are being detected by a single true sensor (2) and processed by tracker electronics (3) for output to a host computer. Furthermore, we could have a wireless source(s) (FIG. 5) as the “sensor” (1), whose signals are detected by a true sensor (2) connected to the electronics unit (3).

The first issue to be resolved when a field source enters the region where tracking is to occur is to determine the operating frequency of the source signal(s). If that source is hardwired into the system and also driven by the electronics unit, the frequency is known. If it is wireless or being driven by other electronics its frequency must be determined. This can be accomplished by using the sensor coils as a probe for detecting energy in the environment. The software resident in the tracker DSP can be made to perform a Fourier analysis of the signals read in to identify if frequency/frequencies in the design set for the system are detected. Only a small portion of the spectrum needs to be analyzed since the candidate operating frequency range always will be known.

The frequency range typically is from a few thousand Hertz to no more than 40 kHz, which does not require a great deal of time to analyze. Digital filtering with the DSP can then be set at the frequencies detected in order to extract the various geometric components of signal coupling from each source coil to each sensor coil. Further, since the set of frequencies existing in the overall system design would always be known, the spectrum scanning can be made very rapid with little concern for aliasing the frequency since only an approximate value is required. The known design frequency nearest the indicated frequency always can be concluded from the indication extracted.

It is important that the signal detection circuitry and algorithm remain efficient because it must run essentially continuously in the background so that the tracker is always able to acquire a source entering the area of a sensor and release a source exiting such an area in real-time. Of course there is the possibility of interfering signals or noise that could lead to a false conclusion so that adequate signal-to-noise margin must be set into the spectrum analysis algorithm as well.

The next problem is to effect synchronism with the source signal(s) in order to optimize data collection. One way of doing this is explained as follows. A typical tracking device generates and samples magnetic fields using data converters whose sampling rate is derived from a single clock source. This is commonly referred to as coherent sampling. One significant advantage of this is that the frequency being detected is exactly the same as the one being generated, and the phase relationship between the current flowing through the magnetic field source and the voltage across the magnetic field sensor is constant and can be easily measured. This is important because the phase relationship is used when computing the transfer function between the sensor voltage and source current, one of the steps in computing position and orientation. It is also the only obstacle to overcome in a non-coherent system once the transfer function is properly computed the subsequent steps are identical to a coherent system.

To understand how a non-coherent system makes up for not knowing the phase relationship, it is helpful to review in detail how a coherent system operates. As previously stated, the requirement is to compute the transfer function between the sensor and source. The tracker DSP measures signals from the source and sensor using a Fourier transform which produces a complex result for each time-series input. Depending on the signal conditioning circuitry, it also may be necessary to adjust the magnitude and phase of either or both results. The result from the source measurement is then multiplied by the matrix

$$[ \begin{matrix}{jω}_{x} & 0 & 0 \\ 0 & {jω}_{y} & 0 \\ 0 & 0 & {jω}_{z}\end{matrix} ]$$

to produce the time derivative of the sinusoidal waveforms (j indicating imaginary part or imaginary number √−1; ω=2πf). At this point the phase differences between the same columns of both matrices are 0 or π. To compute the transfer function between source and sensor, the sensor matrix is multiplied by the inverse of the source matrix, all operations using complex numbers. The resulting matrix will contain zero (or as close as the system accuracy yields) imaginary components. The signal magnitudes will be in the real component, along with the proper sign. The real components are then used in the subsequent calculations.

In a system where the tracker DSP can only measure the sensor signal (one example of a non-coherent system) the transfer function must be computed where the source current is somehow indirectly determined. The magnitude can be a certain value either guaranteed by design or determined during the calibration procedure of the source.

With the exception of the 0 or π ambiguity, the phase of the source is equal to the phase of the sensor divided by j. The ambiguity can be resolved explicitly by imposing a condition at system startup where the sign of the real component of the transfer function is known. For example, if the user locates the sensor in a known position and orientation, the transfer function can be computed reversely and used to resolve the 0 or π ambiguity. The tracker DSP can assemble the following source current matrix

$$[ \begin{matrix}{a}_{x} {ϕ}_{x} & 0 & 0 \\ 0 & {a}_{y} {ϕ}_{y} & 0 \\ 0 & 0 & {a}_{z} {ϕ}_{z}\end{matrix} ]$$

where α and φ are the magnitude and phase of each source signal. In the case of a wireless pseudo-sensor source the amplitude is assumed as staying at a constant amplitude.

In the case where there is no known initial condition yielding phase, the phase relationship must be assumed to be at either the 0 or π ambiguity until an anomaly in the P&O solution rules out one of the values. This means that the tracker electronics and software be capable of adjusting phase relationships dynamically in real-time, which our electronics has been designed to accomplish. Implicit in this design is also the ability to separate real and imaginary components of the received signal. Meantime the true phase relationships are not known but can be determined by adjusting towards or away from the expected value such that in a few cycles optimal performance is detected. This type of operation turns out to be necessary in any event because the phase relationship will not remain constant over time. Therefore, the tracker DSP must constantly update the source phase figures by the difference in phase between consecutive measurements of sensor voltage. If the adjustment exceeds ±π/2, then π gets subtracted or added to the adjustment, since this could only be caused by repositioning the sensor where the sign flips.

Describing this in another way follows. The voltage on the sensor coils is represented as a 3×3 matrix of complex numbers

$$V = [ \begin{matrix}{v}_{X} ( {ω}_{X} ) & {v}_{X} ( {ω}_{Y} ) & {v}_{X} ( {ω}_{Z} ) \\ {v}_{Y} ( {ω}_{X} ) & {v}_{Y} ( {ω}_{Y} ) & {v}_{Y} ( {ω}_{Z} ) \\ {v}_{Z} ( {ω}_{X} ) & {v}_{Z} ( {ω}_{Y} ) & {v}_{Z} ( {ω}_{Z} )\end{matrix} ] ,$$

where v is the voltage on the x, y, and z coils of the sensor and the ω is the frequency of the current flowing through the x, y, and z coils of the source. Matrix K is created by restricting the phases of all elements of V as follows:

```
if Re(Vᵢⱼ) > 0 then
    Kᵢⱼ = Kᵢⱼ
else
    Kᵢⱼ = −Kᵢⱼ
```

The phase of each frequency on all three sensor coils is weighted by the signal strength and averaged as follows.

$${ϕ}_{j} = {\sum }_{i = 0}^{2} {K}_{ij} / {\sum }_{i = 0}^{2} \sqrt{Re ( {K}_{ij} ) + Im ( {K}_{ij} )}$$

The magnetic moment of the source is as follows.

$$M = [ \begin{matrix}{m}_{x} {ϕ}_{0} & 0 & 0 \\ 0 & {m}_{y} {ϕ}_{1} & 0 \\ 0 & 0 & {m}_{z} {ϕ}_{2}\end{matrix} ] ,$$

where m is the current times the effective area of each source winding. Matrix S_{REF} is generated by the known P&O at system initialization. Matrix S is computed from actual data collected by the tracker DSP as follows.
S=V·M⁻¹
The columns of matrix S are then compared to the columns of matrix S_{REF}. If φⱼ is off by π, then S₀ⱼ, S₁ⱼ, and S₂ⱼ will all have the opposite sign when compared to the same elements of S_{REF} and the complex number φⱼ needs to be multiplied by −1. This removes the π ambiguity.

In order to track another pseudo-sensor source that may enter the environment of a sensor, the same Fourier analysis to determine frequency is done and same process for determining the phase relationship. When one of these “sensors” moves onward to where another true sensor detects it, the frequency may unavoidably be detected again, but the phase relationship just discovered can be passed along internally from the first sensor. Operation continues in this way as movement passes through the sensors and as the detectable number of pseudo-sensor sources comes into range. The P&O of the pseudo-sensors is computed based on the sensor geometry and the reference point established. The true sensors must be positioned at known P&O from the single reference point in order to do this. Computation of pseudo-sensor P&O can be performed either in the tracker electronics unit or in the host computer.

One additional event occurs when the number of true sensors on a tracking unit is exhausted but additional movement range is desired. Then an additional tracker system with known P&O of its sensors can be added and tied back to the same host computer. The second tracker system simply goes through the same frequency detection process and synchronization as the first system to perform tracking of the pseudo-sensor(s).

A final point for wireless pseudo-sensor sources concerns their characterization matrix. This set of data normally is retrieved at power up from a PROM incorporated in a tracker source or sensor. It is impossible in this case for a wireless source to provide such a characterization PROM, so such data sets must be pre-loaded into the Tracker Electronics Unit (TEU) memory and be retrieved and used whenever the frequency of a particular wireless source is detected. For this reason the best performance will be obtained if a set of wireless pseudo-sensor sources is always associated with the TEU, or TEUs, servicing a given 3D volume. In summary, we have disclosed a system for detecting non-coherent magnetic signal sources and achieving and maintaining phase synchronization with them without placing any special start-up or harmonic relationships on the source. Further, we have devised a means for extending a string of sensors over a large area to be used successively as the source moves through the sequence of sensors to track low power three-axis field sources without causing distortion via induced eddy currents because of the low level signals involved. The tracker electronics scans for a family of three frequencies per source out of a pre-arranged set intended for the system, computes synchronization, applies characterization data to the signals and computes position and orientation results for output to a host computer. Because of the independent manner in which the tracker determines frequency and then achieves and maintains synchronization, pseudo-sensor sources can achieve operation over even larger spaces than a single tracker can accommodate by concatenating additional tracker systems with their pre-spaced sensors and connecting to the same host computer. Note that a source also can be tracked if it is powered by another system as opposed to being driven by a battery due to the ability to synchronize and achieve coherency. Also, due to the reciprocity between ‘sources’ and ‘sensors’ as discussed above, inverse operation is also possible; that is, where it is desirable to synchronize one or more sensors with a source having a known phase.

1. An AC magnetic tracking system, comprising:
a magnetic field source including a first set of magnetic field coils, each coil being driven at a different operating frequency;
a sensor having a second set of magnetic field coils; and
processing electronics connected to the sensor operative to perform the following functions:
a) synchronize the second set of field coils to the operating frequencies, and
b) determine the position and orientation of the source using the synchronized frequencies.

2. The tracking system of claim 1, wherein the processing electronics is further operative to determine at least one source coil frequency using the second set of field coils in the sensor.

3. The tracking system of claim 1, wherein the processing electronics is further operative to determine at least one source coil frequency by performing the following functions:
a) performing a Fourier analysis of frequencies detected by the second set of magnetic field coils, and
b) filtering the frequencies to extract geometric components of signal coupling from the source to the sensor.

4. The tracking system of claim 3, wherein the processing electronics is further operative to determine each source coil frequency as a function of the frequencies detected by the sensor coils.

5. The tracking system of claim 3, wherein the processing electronics further includes a memory for storing candidate frequencies associated with the source.

6. The tracking system of claim 3, wherein:
the processing electronics further includes a memory for storing candidate frequencies associated with the source; and
after determining one of the frequencies of the source using the sensor coils, additional frequencies associated with the source and its calibration/characterization data are obtained from the memory.

7. The tracking system of claim 1, wherein the processor synchronizes the second set of field coils to the operating frequencies by performing the following functions:
assuming the phase of the source is equal to the phase of the sensor divided by j; and
resolving phase ambiguity at 0 or π.

8. The tracking system of claim 7, wherein the magnitude of the source is guaranteed or determined during a calibration procedure.

9. The tracking system of claim 7, wherein phase ambiguity is resolved by adjusting up or down from an expected value.

10. The tracking system of claim 1, wherein the processing electronics is interfaced to an additional tracker system having sensors with a known position and orientation to expand the volume in which the tracking is carried out.

11. The tracking system of claim 1, wherein the source and sensor each include a set of three orthogonal coils.

12. The tracking system of claim 1, wherein the sensor is stationary.

13. The tracking system of claim 1, including a plurality of sensors.

14. The tracking system of claim 1, including a plurality of sources, each source including a set of coils driven at a different set of frequencies.

15. The tracking system of claim 1, wherein the source is disposed on a subject or object to be tracked.

16. The tracking system of claim 1, wherein the source is a wireless source with a housing including the following components:
the first set of magnetic field coils;
a battery; and
circuitry operated by the battery for driving each coil to generate a different frequency.

17. The tracking system of claim 1, further including:
a memory for storing characterization information regarding the source, the sensor, or both; and
the processing electronics uses the stored characterization information in determining the position and orientation of the source.

18. A tracking method, comprising the steps of:
providing the system of claim 1;
generating a sensor signal matrix representing the response of each coil of the sensor to each coil of the source; and
calculating the position and orientation of the source using the signal matrix.

19. The method of claim 18, including the steps of:
storing characterization information regarding the source, the sensor, or both; and
applying the characterization information to the signal matrix.

20. The method of claim 18, including the steps of:
supporting multiple sources on a subject or object, each source operating at a different set of frequencies; and
determining the movement of the subject or object by calculating the change in position or orientation of the sources.
